(19) United States
(12) Patent Application Publication
(10) Pub. No.: US 2017/0218989 A1
(43) Pub. Date: Aug. 3, 2017

(54) ASSEMBLY HOLDER AND ASSEMBLY

(71) Applicant: ZF Friedrichshafen AG, Friedrichshafen (DE)

(72) Inventors: Thomas Schober, Hahnbach (DE); Oliver Küpfer, Gräfenberg (DE)

(73) Assignee: ZF Friedrichshafen AG, Friedrichshafen (DE)

(21) Appl. No.: 15/329,353

(22) PCT Filed: Jul. 2, 2015
(86) PCT No.: PCT/EP2015/065056

§ 371 Date: Jan. 26, 2017

(30) Foreign Application Priority Data
Aug. 1, 2014 (DE) 10 2014 215 229.1

(51) Int. Cl. F16B 5/04; B29C 65/60; B29C 65/00; F16B 19/06

(52) U.S. Cl. CPC F16B 5/04; F16B 19/06; B29C 65/606; B29C 66/73921; B29C 66/73941; B29C 66/742

(57) ABSTRACT

A module mount having at least one module that can be mounted on the module mount, wherein the module can be mounted on the module mount via at least one caulking element, such that the respective caulking element, which is composed of a thermoplastic, extends through a hole in a section of the respective module that can be mounted on the module mount made of a thermoplastic or thermoset, and is hot-caulked at an end projecting out of the hole, wherein at least one projection is formed on the section of the respective module that can be mounted on the module mount in the region of the respective hole of the section of the respective module that can be mounted on the module mount made of the thermoplastic or thermoset, which projection is engaged in a press fit with the hot-caulked end of the respective caulking element.

The disclosure relates to a module mount according to the preamble of claim 1, having at least one module that can be mounted on the module mount, and a module according to the preamble of claim 10.

Module mounts having modules mounted thereon, e.g. sensors, are known from automobile applications, for example, in which the, or each, module is mounted on the module mount via at least one caulking element, such that the respective caulking element, which is composed of a thermoplastic, extends through a hole in a section of the respective module that is to be mounted on the module mount, composed of a thermoplastic or thermoset, and is hot-caulked at an end projecting out of the hole. When the end extending out of the hole and projecting opposite the hole is hot-caulked, forces are exerted on the hole and so-called weld lines running in the region of the hole. This may lead to damage to the module that can be mounted on the module mount.

Based on this, the present disclosure addresses the object of creating an improved bond between the module mount and a module that can be mounted thereon.

This object is achieved by means of a module mount according to claim 1 and by means of a module according to claim 10. In accordance with the disclosure, at least one projection is formed in the region of the respective hole in the section of the respective module that can be mounted on the module mount, composed of the thermoplastic or thermoset, on the section of the respective module that can be mounted on the module mount, which is engaged in a press fit with the hot-caulked end of the respective caulking element. When the end of the respective caulking element extending out of the respective hole is hot-caulked, the thermoplastic substance is pressed onto the, or each, projection. Loads to the mountable module in the region of the hole are avoided. The hot-caulked end of the respective caulking element engages in a press fit with the, or each, projection formed on the corresponding section of the respective mountable module, by means of which tolerances are compensated for, and play between the module mount and the mounted module is reduced.

According to a first advantageous further development of the disclosure, an annular projection, extending around the respective hole, is formed on the respective section, which interacts with the respective caulking element, of the respective module that can be mounted on the module mount. According to a second, alternative advantageous further development of the disclosure, numerous projections are formed on the respective section of the respective module that can be mounted on the module mount, which interacts with the respective caulking element, which projections are disposed around the respective hole along an annular contour, at a spacing to one another. Both further developments enable a mounting of the module that is to be mounted on the module mount without play.

The, or each, caulking element is preferably an integral component of the module mount, wherein the, or each, caulking element projects in the manner of a pin in relation to the module mount. This design is then advantageous when the module mount, as well as the, or each, caulking element, is made of a thermoplastic. In this case, separate caulking elements are no longer necessary, because the caulking elements are then integral components of the module mount. Such a design is particularly simple, and therefore advantageous.

Preferred further developments can be derived from the dependent claims and the following description. Exemplary embodiments of the disclosure shall be explained in greater detail based on the drawings, without being limited thereto. Therein:

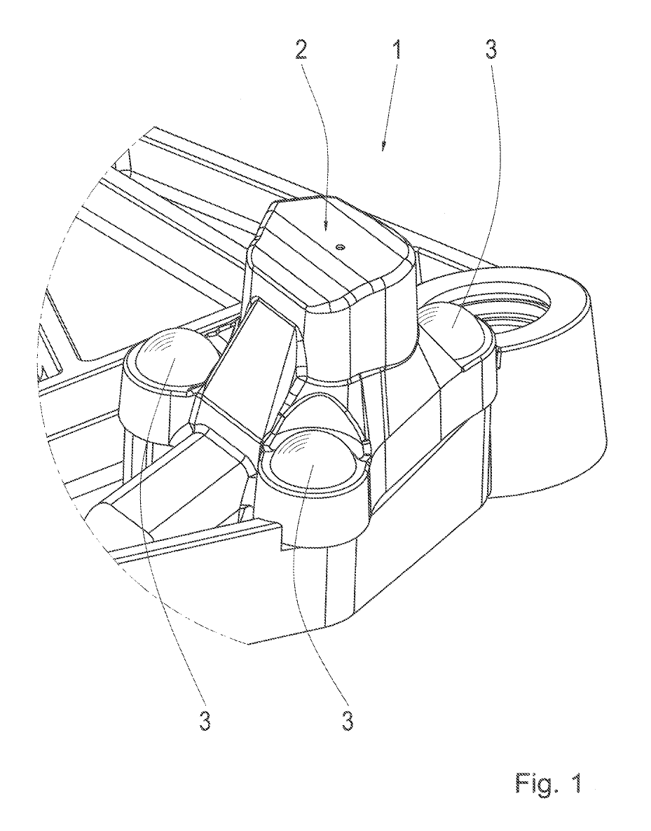

FIG. 1 shows a section of a module mount with a module mounted thereon;

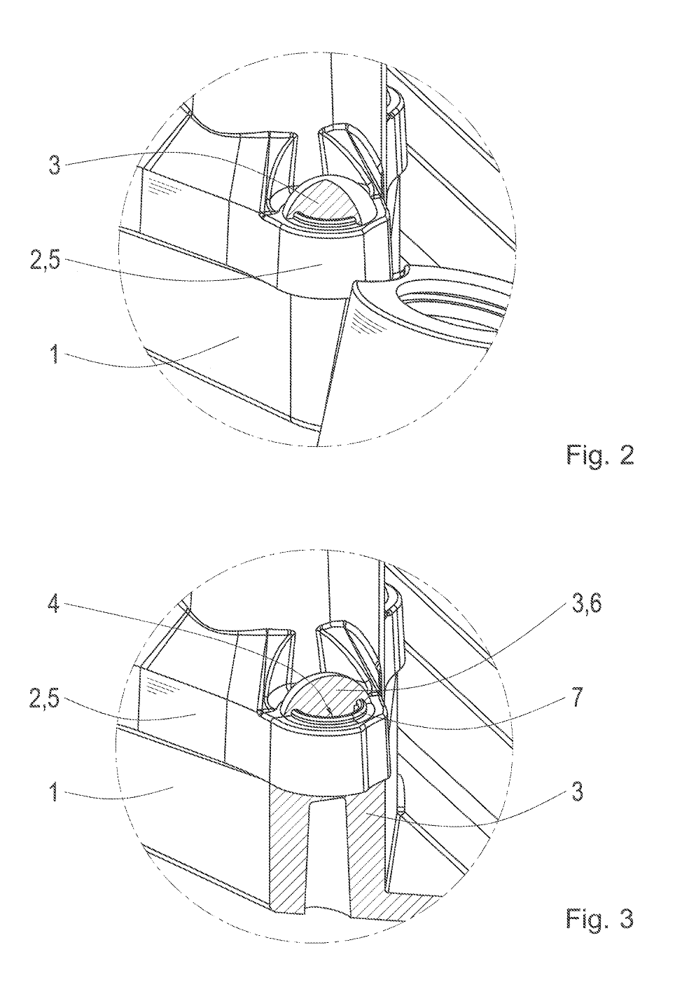

FIG. 2 shows a detail of FIG. 1;

FIG. 3 shows the detail of FIG. 2, in a partial cross section;

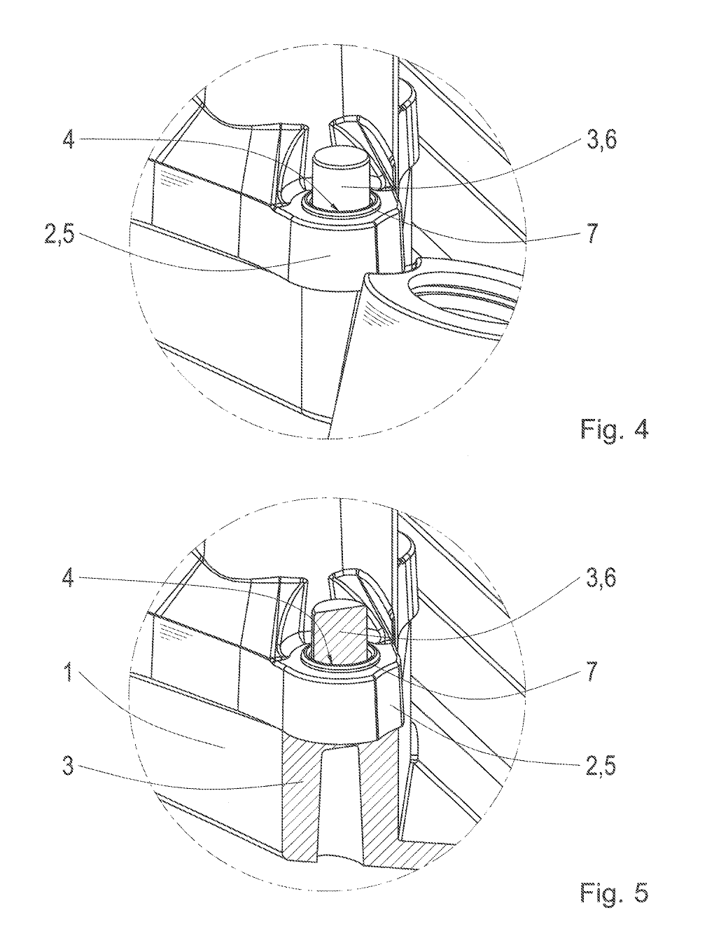

FIG. 4 shows the detail of FIG. 2, in the state prior to hot-caulking;

FIG. 5 shows the detail of FIG. 4, in the state prior to hot-caulking; and

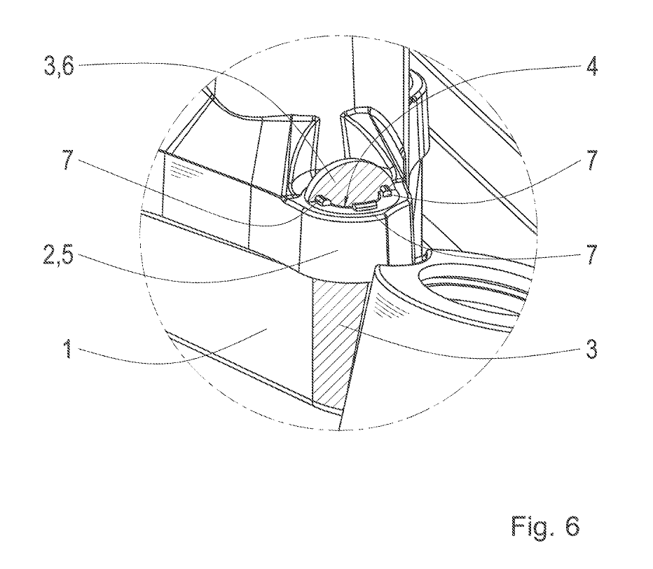

FIG. 6 shows an alternative to FIG. 3.

FIG. 1 shows a section of a module mount 1 in the region of a module 2 mounted on the module mount 1. In the exemplary embodiment shown, the module mount 1 is a section of a transmission control device, on which a sensor in the form of a module 2 is mounted.

Numerous caulking elements 3 are used to mount the module 2 on the module mount 1 in the exemplary embodiment shown herein. Thus, the module 2 designed as a sensor in FIG. 1 is mounted on the module mount 1 via three caulking elements 3. It should be noted here that the use of three caulking elements is of a purely exemplary nature. It is also possible to user fewer than three caulking elements or more than three caulking elements to mount a module on a module mount. Depending on the mountable module 2, it is also possible to use a single caulking element for mounting the module 2 on the module mount 1.

The caulking elements 3 are made of a thermoplastic. The caulking elements 3 extend through a hole 4 in a section of the respective module 2, composed of a thermoplastic or thermoset, that can be mounted on the module mount 1, and project opposite this hole 4 at one end 6.

In order to mount the module 2 on the module mount 1, the end 6 of the respective caulking element 3 extending out of the hole 4 is hot-caulked, wherein FIGS. 4 and 5 show the end 6 of the caulking element 3 extending out of the hole 4 in the state prior to hot-caulking, and FIGS. 2 and 3 show this end 6 in the hot-caulked state.

In accordance with the disclosure, at least one projection 7 is formed on the section 5 of the module 2, which interacts with the respective caulking element 3, in the region of the respective hole 4 of the section 5 of the respective module 2 that can be mounted on the module mount 1, composed of the thermoplastic or thermoset, which is engaged in a press fit (see FIG. 3, in particular) with the hot-caulked end 6 of the respective caulking element 3.

In the exemplary embodiment shown in FIGS. 1 to 5, a single annular projection 7 extending around the hole 4 is formed on the section 5 of the respective module 2 that can be mounted on the module mount 1 interacting with the respective caulking element 3, which is in a press fit engagement with the end 6 when the end 6 of the caulking element 3 is in the hot-caulked state.

FIG. 6 shows a variation, in which numerous projections 7 are formed on the section 5 of the respective module 2 that is to be mounted on the module mount 1 interacting with the respective caulking element 3, which are disposed along an annular contour, or circular contour, around the hole 4, at a spacing to one another.

In the exemplary embodiments, the caulking elements 3 are each integral components of the module mount 1. Each of the caulking elements 3 projects opposite the module mount 1 thereby, which, like the caulking elements 3, is composed of a thermoplastic. The variation in which the caulking elements 3 are an integral component of the module mount 1 enables a particularly simple mounting of the module 2 on the module mount 1, because the caulking elements 3 are a component of the module mount 1 that cannot become lost, and directly define the position of the module 2 that is to be mounted.

Although the variation, in which the caulking elements 3 are an integral component of the module mount 1, is preferred, it is alternatively also possible to design the, or each, caulking element 3 as a separate component. In this case, the caulking elements 3 are then designed in the manner of rivets, which extend with a first end into the respective hole in the section of the respective module that can be mounted on the module mount, composed of the thermoplastic or thermoset, and extend with an opposite, second end into a hole in the module mount, extending through it, and which is hot-caulked in each case at the two projecting ends.

This variation is typically selected when the module mount is made of a metal, such that the thermoplastic caulking elements 3 cannot be designed as an integral component of the module mount 1.

The present disclosure herein enables a particularly advantageous mounting of modules on a module mount while compensating for tolerances between the module and the module mount. There is no danger of damage to the respective module that is to be mounted when the, or each, of the caulking elements is hot-caulked.

### REFERENCE SYMBOLS

1 Module mount
2 Module
3 Caulking element
4 Hole
5 Section
6 End
7 Projection

1. A module mount having a module configured to be mounted on the module mount, wherein the module is configured to be mounted on the module mount via at least one caulking element, such that the at least one caulking element extends through a hole in a section of the module that can be mounted on the module mount wherein the section is hot-caulked to an end of the at least one caulking element projecting out of the hole, wherein a projection is formed on the section in a region of the hole, which is in a press fit engagement with the hot-caulked end of the at least one caulking element.

2. The module mount according to claim 1, wherein the projection is an annular projection extending around the hole.

3. The module mount according to claim 1, wherein a plurality of projections are formed on the section of the module that can be mounted on the module mount, wherein the plurality of projections are disposed along an annular contour around the hole spaced apart from one another.

4. The module mount according to claim 1, wherein, at least one caulking element is an integral component of the module mount.

5. The module mount according to claim 4, wherein the at least one caulking element projects in the manner of a pin in relation to the module mount.

6. The module mount according to claim 4, wherein the module mount is composed of thermoplastic.

7. The module mount according to claim 1, wherein the at least one caulking element is a separate component from the module mount.

8. The module mount according to claim 7, wherein at least one caulking element is a rivet that passes through the hole with a first end, and passes through a second hole in the module mount with a second end, and wherein the at least one caulking element is hot-caulked at both ends.

9. The module mount according to claim 7, wherein the module mount is made of metal.

10. A module configured to be mounted on a module mount, such that the module can be mounted on the module mount via at least one caulking element, and such that the at least one caulking element extends through a hole in a section of the module that can be mounted on the module mount wherein the at least one caulking element is hot-caulked at an end projecting out of the hole, wherein at least one projection is formed on the section of the module in a region of the hole, which is engaged in a press fit with the hot-caulked end of the caulking element.

11. The module according to claim 10, wherein the projection is an annular projection extending around the hole.

12. The module according to claim 10, wherein a plurality of projections are formed on the section interacting with the caulking element, wherein the plurality of projections are disposed along an annular contour around the hole spaced apart from one another.

13. The module mount according to claim 1, wherein the at least one caulking element is composed of thermoplastic.

14. The module mount according to claim 1, wherein the module mount is composed of thermoplastic or thermoset.

15. The module mount according to claim 5, wherein the at least one caulking element protrudes away from the module mount.

16. the module mount according to claim 1, wherein the projection extends outward from the section of the module.

17. The module according to claim 10, wherein the at least one caulking element is composed of thermoplastic.

18. The module according to claim 10, wherein the module mount is composed of thermoplastic or thermoset.

19. The module mount according to claim 10, wherein the at least one projection extends outward from the section of the module.

20. A module configured to be mounted on a module mount, the module comprising:
a section configured to be mounted on the module mount,
a hole extending through the section, wherein the hole is configured to accept a pin shaped caulking element that extends from the module mount, and
an annular projection extending outward from the section around the hole, wherein the annular projection is configured to engage the caulking element in a press fit manner when an end of the caulking element is hot-caulked to the section of the module.
